(19) United States
(12) Patent Application Publication
(10) Pub. No.: US 2025/0153321 A1
(43) Pub. Date: May 15, 2025

(54) BI-DIRECTIONAL HEX HEAD SOCKET REMOVING TOOL

(71) Applicant: Robert Doroslovac, Massillon, OH (US)

(72) Inventor: Robert Doroslovac, Massillon, OH (US)

(21) Appl. No.: 18/425,342

(22) Filed: Jan. 29, 2024

Related U.S. Application Data
(60) Provisional application No. 63/548,361, filed on Nov. 13, 2023.

(51) Int. Cl. B25B 23/10; B25B 13/06; B25B 23/00

(52) U.S. Cl. CPC B25B 23/108; B25B 13/065; B25B 23/0035

(57) ABSTRACT

A socket wrench tool for turning damaged fastener heads. The tool comprises a socket body having a plurality of longitudinal hex engagement surfaces positioned around a center axis. Each engagement surface has a center channel defining a pair of spaced parallel longitudinal engagement edges of a depth that beyond the maximum depth of the socket that engages below the bolt damaged surface of the extraction or insertion.

This application claims the benefit of U.S. Provisional Application No. 63/548,361, filed on Nov. 13, 2023.

### BACKGROUND OF THE INVENTION

### 1. Technical Field

This invention relates to extraction tools that engage a damaged fastener for rotation extraction.

### 2. Description of Prior Art

See, for example, U.S. Pat. Nos. 4,607,547, 4,724,730, 6,237,448, 6,327,939, 6,854,360 and 7,290,467.

In U.S. Pat. No. 4,607,547, a stripped hex tool drive socket is disclosed having auxiliary interior ribs to engage and form grooves in the bolt surface by application of hammering force and then rotational force by a tool.

U.S. Pat. No. 4,724,730 discloses a cam lock socket having a plurality of pins with oval shaped cross sections positioned in scalloped shaped recesses for camming out of respective surfaces to tighten on a nut head of a bolt.

U.S. Pat. No. 6,237,448 illustrates a variety of grip tightening hex head wrench configurations having annular bolt head engagement surfaces with a spring opening of a closure gap between the open and closed position with fastener head contact.

U.S. Pat. No. 6,854,360 is directed to a method of manufacturing a socket tool having a plurality of helically arcuate locking grooves in the socket.

U.S. Pat. No. 7,290,467 is directed to a socket wrench having a number of longitudinally extending members therein mounted within wall circumferential slots of work piece receiving openings secured in place by a flexible web.

### SUMMARY OF THE INVENTION

An omni-directional multi-grip socket bit for hexagonal fastener engagement having hex surface fastener engagement surfaces with longitudinally extending locking engagement channels there within. Each engagement channel defines a pair of fastener engagement edges extending below the fastener's damaged surface for surface engagement and rotational force extraction. The locking engagement channel edge surfaces exert radial arcuate camming rotational forces improving gripping to effectively manipulate the work piece in the direction of rotation desired.

### DESCRIPTION OF THE DRAWINGS

FIG. 1 is an enlarged top and front perspective view of the hex socket wrench of the invention.

FIG. 2 is an enlarged top plan view thereof.

FIG. 3 is an enlarged bottom and rear perspective view thereof.

FIG. 4 is a graphic illustration of the engagement channels engagement angular orientation for fastener edge engagement.

FIG. 5 is an enlarged graphic sectional view of the hex socket extractor engaged on a fastener shown in broken lines.

### DETAILED DESCRIPTION OF THE INVENTION

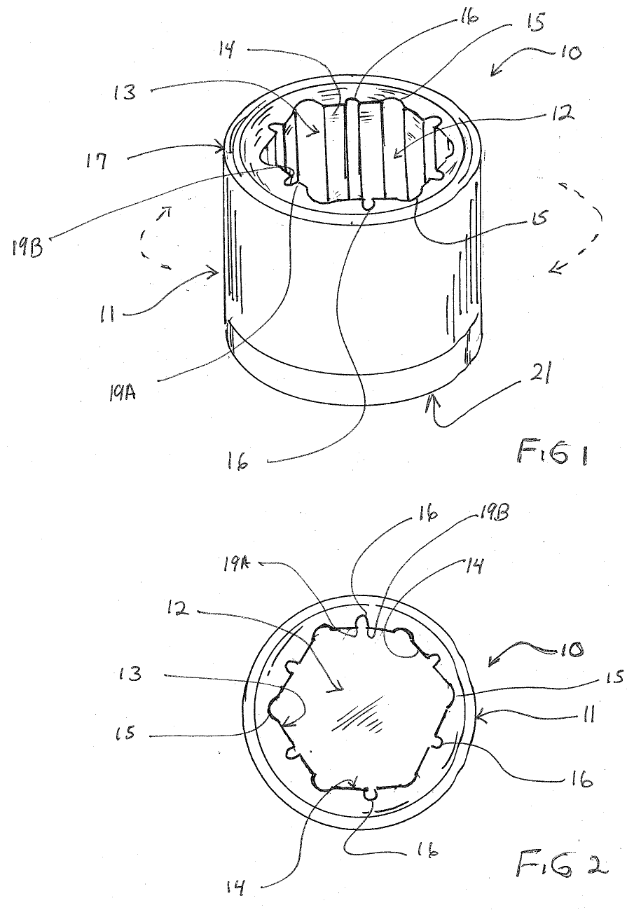

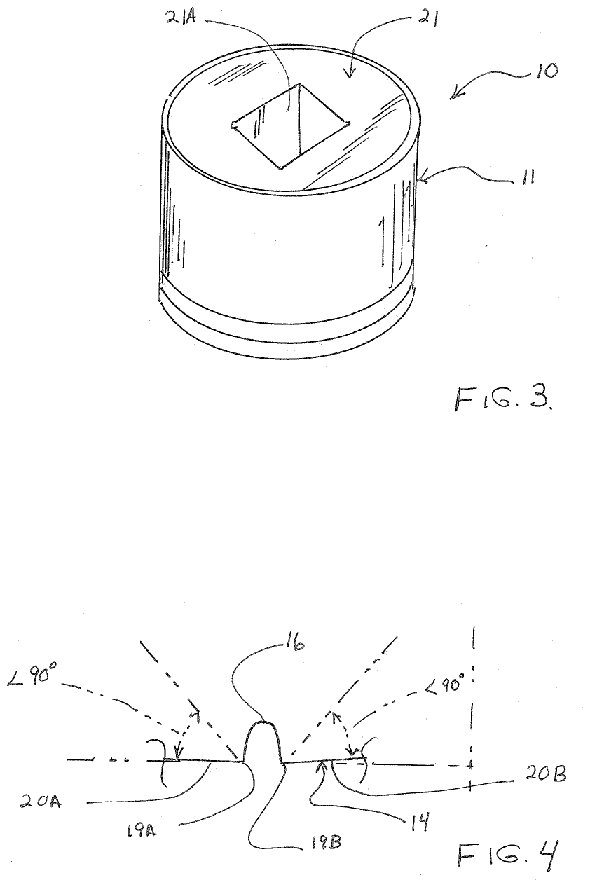

Referring to FIGS. 1-3 of the drawings, an anti-slip hex socket wrench 10 of the invention can be seen having a cylindrical screw body 11 with an open-ended annular cavity 12 with an interior wall surface 13. A plurality of hexagonal elongated engagement surfaces 14 are formed radially within the interior wall surface 13 defining pairs of opposing hex fastener engagement surfaces, best seen in FIG. 2 of the drawings.

The respective engagement surfaces 14 are interconnected by contoured curvilinear recesses 15 defining an engagement hex socket configuration.

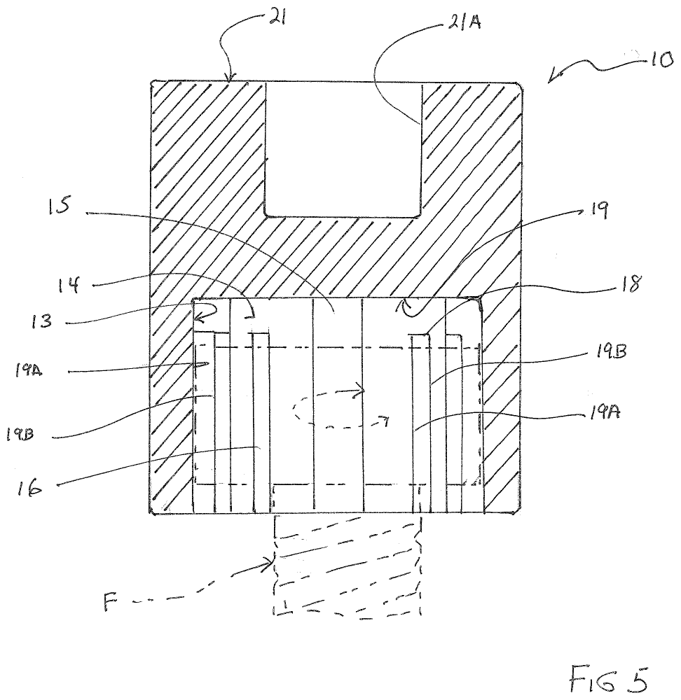

Each of the respective fastener engagement surfaces 14 have an elongated channel 16 cut midway therein extending from the open socket end 17 to a termination point 18 in spaced relation to an interior socket bottom 19, illustrated best in FIGS. 4 and 5 of the drawings.

Each of the channel cuts 16 defines a pair of corresponding spaced parallel fastener rotatable force elongated engagement edges 19A and 19B. The effacing position of the so-defined multiple cut channels 16 and their respective force engagement edges 19A and 19B are therefore in opposing orientation to one another and will provide the multiple respective independent force engagement edges 19A and 19B paired orientation for bi-directional rotation that will be described in detail hereinafter.

The positioning of the respective force engagement edges 19A and 19B therefore are critical to the effective operation providing multiple engagement points determined to be the most vulnerable on the fastener F subject to potential slips during tool rotation impingement force as seen in broken lines in FIG. 5 of the drawings. Therefore, as the socket 10 of the invention engages the widest points of the so engaged fastener F, the respective channel formed engagement edges 19A and 19B act as cutting edges will thereby dig in to the fastener F opposing surfaces with the fastener surface material deformation under force thereby enhancing the rotational grip there between.

Another aspect of the formation of the engagement edges 19A and 19B illustrated in FIG. 4 of the drawings is their angular trailingsurface 20A and respective leading surfaces 20B depending on the rotational direction which in this example is an angle orientation of less than a true 90 degrees due to the contoured nature of the respective inner socket surfaces 14 formed within by the interlinking contoured curvilinear recesses 15.

It will be evident that this unique orientation provides enhanced fastener embedment of the edges 19A and 19B beyond the linear surface engagement heretofore achieved by prior art extraction sockets. It will be seen that the cylinder screw bit body 10 bottom 21 will have a tool receiving bore 21A therein to provide adaptive for registration tool use having a male or female socket tool in both manual and power-driven alternate forms as will be understood by those skilled in the art.

It will thus be seen that a new and novel anti-slip hex socket extractor of the invention has been illustrated and described herein and that changes and modifications may be made without departing from the spirit of the invention. Therefore, I claim:

1. An omni-directional multi-grip socket for hex fasteners comprising,
a screw bit body having a fastener receiving open end portion and a tool engagement end portion,
a plurality of annular spaced interior fastener engagement surfaces in said fastener receiving open end portion,
contoured curvilinear recesses between said interior fastener engagement surfaces interconnecting said fastener engagement surfaces,
elongated channel cut within said fastener engagement surfaces, said channel cuts defining pairs of parallel elongated fastener engagement edges.

2. The omni-directional multi-grip socket for hex fasteners set forth in claim 1 wherein each of the elongated channel cuts extending from the screw body fastener receiving open end portion to a termination point in spaced relation to the fastener receiving interior bottom.

3. The omni-directional multi-grip socket for hex fasteners set forth in claim 1 wherein said contoured curvilinear recesses joined between said fastener engagement surfaces interlink and define fastener engagement surfaces in a hex fastener engagement orientation.

4. The omni-directional multi-grip socket for hex fasteners set forth in claim 1 wherein said fastener engagement surfaces are transversely sloped from said respective fastener engagement edges to said contoured curvilinear recesses defining spaced opposing pairs of angularly disposed fastener engagement surface extending from said respective channel cuts.

5. The omni-directional multi-grip socket for hex fasteners set forth in claim 3 wherein one of said angularly disposed fastener engagement surfaces are of a bi-sectional angle to said channel cut of less than 90 degrees thereto.

6. Multiple bi-directional grip socket for hex headed fasteners comprising,
a socket body having a socket drive tool engagement fitting end,
a hex fastener socket open receiving fitting within said oppositely disposed end,
a plurality of curvilinear interconnecting recesses defining fastener engagement surfaces there between,
elongated engagement channel in said respective fastener engagement surfaces,
said channel cuts further define pairs of parallel elongated fastener engagement edges between said defined fastener engagement surfaces.

7. The omni-directional multi-grip socket for hex fasteners set forth in claim 6 wherein said defined fastener engagement surfaces have transverse angular slope to said curvilinear intersecting recesses of less than 90 degrees from said channel cuts.
